(19) United States
(12) Patent Application Publication
(10) Pub. No.: US 2024/0001367 A1
(43) Pub. Date: Jan. 4, 2024

(54) Test Device for Analyte in A Fluid Sample

(71) Applicant: Zhejiang Orient Gene Biotech Co.,Ltd., Huzhou (CN)

(72) Inventors: Jianqiu FANG, Huzhou (CN); Siyu LEI, Huzhou (CN); Hua ZHANG, Huzhou (CN)

(21) Appl. No.: 18/183,716

(22) Filed: Mar. 14, 2023

Related U.S. Application Data
(60) Provisional application No. 63/352,036, filed on Jun. 14, 2022.

(30) Foreign Application Priority Data
May 23, 2022 (CN) 2022105647065
May 31, 2022 (CN) 2022106085309
Jun. 6, 2022 (GB) 2208268.9

(51) Int. Cl. B01L 3/00

(52) U.S. Cl. CPC B01L 3/505; B01L 3/5023

(57) ABSTRACT

The present invention provides a test device. The device includes a testing element and a housing accommodating the testing element; the housing is formed by folding a card which is made of a paper material. The testing element is located in the housing, and the housing is allowed to be in different change states to achieve the detection or assay of an analyte in a sample.

### CROSS-REFERENCE TO RELATED APPLICATIONS

The present application claims priority to a Chinese prior application No. CN2022105647065 and filed on May 23, 2022, a Chinese prior application No. CN2022106085309 and filed on May 23, 2022, as well as a U.S. prior provisional application No. 63/352,036 and filed on Jun. 14, 2022, and a UK prior application No. GB2208268.9 and filed on Monday, Jun. 6, 2022; the entire contents of the above application, including the description, claims, abstract and abstract drawings of which are incorporated herein as a portion of the present invention.

### FIELD OF THE INVENTION

The present invention relates to a device for collecting and detecting a liquid sample, in particular, a device for collecting and detecting an analyte in a liquid sample in the field of rapid diagnosis, such as a urine and saliva collection and testing device.

### BACKGROUND OF THE INVENTION

The following description is merely an introduction to the background art and not to limit the present invention.

At present, the test device for detecting the presence or absence of an analyte in sample is widely used in hospitals or homes, and such test device for rapid diagnosis comprises one or more test strips, such as early pregnancy detection, drug abuse detection, etc. The test device for rapid diagnosis is very convenient, and the test result can be obtained from the test strip after one minute or no more than ten minutes.

The drug detection is widely used by drug control department, Public Security Bureau, drug rehabilitation centers, physical examination centers, the national conscription offices, etc. The drug detection is diverse and frequent. Some detections need to collect samples and then samples are detected in professional testing agency or testing laboratories, and some detections needs to be completed in the site in time, for example, roadsides, for example, persons who drive after drug use need to be tested on the spot (referred to as “Drug Driving”), to obtain the results in time.

For example, the detection of saliva samples is gradually accepted and favored by testing agencies or testing personnel due to convenient collection. In some literatures, various sample collection and test devices for clinical and domestic uses have been obtained and described. For example, the U.S. Pat. No. 5,376,337 discloses a saliva sampling device in which a piece of filter paper is used to collect saliva from the mouth of a subject and deliver saliva to an indicator reagent. The U.S. Pat. Nos. 5,576,009 and 5,352,410 have disclosed a syringe-type fluid sampling device.

For another example, a US patent application with the application number of Ser. No. 14/893,461 and publication number of US2016/0121322A1 discloses a test device for a sample; the patent only discloses some basic detection schemes and principles, and appears more difficult in the actual implementation of a specific product. For example, how to compress the pipet tip for absorbing saliva and how to move it if the cover body combination is matched with the detection combination, as well as how to mix with liquid effectively, the practical effects are undesirable.

Moreover, a large number of plastics are used as the package or carriers of a testing element of these test devices above, which brings huge challenge for the subsequent environmental treatment, causes high cost in production and processing. Furthermore, practical detection operation is tedious, and it is complex for some personnels of non-professional institutes. If it is easy for a person without any medical background to operate the device, the device is more universal and popular to the control of diseases.

In view of the above technical problems in some conventional products, it is necessary to improve them and provide an alternative approach to solve the drawbacks of the prior art.

### BRIEF SUMMARY OF THE INVENTION

Directed to the above situation, to overcome the shortcomings in the prior art, the objective of

the present invention is to provide a device for detecting an analyte in a fluid sample; paper is used as a test carrier of the device, and a testing element is disposed in the carrier, and the paper carrier is capable of achieving changes in shape arbitrarily, which is convenient for detection and easy to be stored and treated after the detection is finished.

In one aspect, the present invention provides a test device, including a housing accommodating a testing element, where the housing is formed by folding.

In some embodiments, the housing is made of a paper material, and formed by folding the paper material to form the housing to contain the test element therein.

In some embodiments, the folded housing may be opened for test when in need of detection.

In some embodiments, when the housing is opened partially, the sample application area of the testing element is exposed such that the sample application area can receive a liquid sample or contact a liquid sample. In some embodiments, the opened carrier may be closed once the sample is received such that a receiving area of the testing element is located in the housing to be protected, expectedly, protected by the closed part of the housing.

In some embodiments, the foldable housing may be kept standing by relying on the opened structure of the housing when opened, and the testing element is kept standing within the housing as well. In some embodiments, when the housing is standing, the sample application area of the testing element may be allowed to be in the liquid sample. In some embodiments, the liquid sample is contained in a container; the sample application area of the testing element is standing in the container, and the opened structure is standing at both sides of the container.

In some embodiments, the housing or the carrier includes the testing element therein, and the testing element includes a test area for testing an analyte in a liquid sample and a sample application area for contacting the liquid sample, and the test area is in fluidic communication with the sample application area.

In some embodiments, the housing or the carrier includes a window for reading the test area of the testing element.

In some embodiments, the housing or the carrier includes a space for accommodating the testing element therein, and the space is occupied by the testing element or the space is used for bearing the testing element thereon.

In some embodiments, the folding refers to multi-folding of an integral paper sheet. In some embodiments, the folding is performed on the basis of fold lines. In some embodiments, the sheet is a rectangle, and the sheet includes fold lines and is folded along fold lines to form the housing or carrier.

In some embodiments, the folding of the fold lines renders the housing to be in different states, thus achieving the contact between the testing element and the liquid sample and obtaining a test result, or reading a test result.

In some embodiments, the housing has different states, in case of being in different states, the housing is capable of achieving the contact between the testing element and the liquid sample and obtaining the test result, or reading the test result.

In some embodiments, the states refer to a first closed state and a second open state; in case of being in the first state, the testing element is fully covered by the housing; in case of being in the second state, a portion of the sample application area of the testing element is exposed to contact the fluid sample, and then the housing may change into the initial state from the open state.

In some embodiments, the housing includes one or two elements capable of being in closed and open states; the elements are in the closed or open state such that the housing is in the different closed or open state.

In some embodiments, the closed or opened elements are covered on or around the sample application area of the testing element. When the two elements are opened, a part of the sample application area is exposed, or completely exposed; when the two elements are in the closed state, the sample application area is located between the two elements, thus being protected or covered by the two elements, or deposited in the sample that formed by the closed two elements.

In some embodiments, when the elements are in the open state, the two elements allow the housing or carrier to be in a standing state or the whole house can be standing status depending on the two elements.

In some embodiments, when the elements are in the closed state, the two elements are closed via a closing structure or a closing device, or a locking structure.

In some embodiments, the elements are closed by the closing structure including a buckle, a splice, a lock catch, a snap fastener and a magnet.

In some embodiments, the magnet renders the elements to be closed via attraction of positive and negative electrodes, or the elements are closed via a magnetic magnet and a metal with attraction.

In some embodiments, when the fluid sample is contained by the container, the two elements to be opened are standing at both sides of the container such that the carrier is in a standing state, and the sample application area of the testing element is inserted into the container to contact the fluid sample. In some embodiments, the sample application area of the testing element is drawn from the container once contact such that the two elements are closed. A test result of the test area is then read, or a test result on the test area is read through a window after the sample application area of the testing element contacts the fluid sample. The reading here may be implemented via naked eyes, photographing and other ways.

In the other aspect, the present invention provides a test device; the device is formed by folding a card; the card includes a folding area with a slot, a window area with a window, a supporting area with a side for supporting the testing element, and movable areas connected with the window area and the supporting area; after being folded, the folding area, the window area and the supporting area are bonded with each other as to protect the test area being moved ; and the movable areas are located at both sides of the testing element. The movable areas may be in a closed or open state.

In some embodiments, the present invention provides a test device; the device is formed by folding a card; the card includes an area with a slot, a window area with a window, a supporting area with a side for supporting the testing element, and movable areas connected with the window area and the supporting area; after being folded, the slot area is bound on the supporting area; the window area is bound on the slot area; and the movable areas are located at both sides of the testing element, being in a state capable of being closed or unfolded.

In some embodiments, two movable areas are provided with a structure which renders the movables areas to be closed or expanded or opened. Elements may be closed by the closing structure, in some embodiments, via buckling, splicing, locking, pressing and a magnet. When elements need to be expanded, the buckling, splicing, locking, or pressing structure is removed, or the magnet is separated to remove the closing. In some embodiments, the unfolded state includes separation; and movable elements serve as a supporting structure to make the test device standing by itself. In some embodiments, the expanding of the movable areas includes that the movable areas overturn to cover on the window area or the supporting area.

In some other embodiments, the card is made of a paper material.

In some other embodiments, the present invention provides a test device, including a window area and a supporting area; the window area is hinged to the supporting area. In some other embodiments, a bonding area for bearing the testing element is disposed on the supporting area, and the testing element is bound on the bonding area. In some embodiments, the test area of the testing element is bound on the supporting element. In some embodiments, a drying agent is stick on the bonding area of the supporting area; the drying agent has double-sided pasting functions; the test area of the testing element is stick on the drying agent. In some embodiments, there are two movable areas connected to the window area and the supporting area; the movable areas are in a closed or an expanded state; in case of being the closed state, the sample application area of the testing element is covered or protected by the closed area; in case of being in the expanded state, the expansion of the movable areas forms a certain included angle to play the supporting role, for example, the way as shown in FIG. 5. Of course, another way of the expansion is that the movable areas are overturned to be stick on the back of the supporting area and the window area, thus forming the way as shown in FIG. 13. The two expanded elements may be bound via a buckle, magnet adsorption and the like.

In the other aspect, a method for detecting an analyte in a fluid sample is provided; the method includes:
providing a test device, where the device includes a housing folded by a paper card, and the housing contains a testing element for testing an analyte in a fluid sample; the housing includes an area for bearing the test area of the testing element and an area for bearing the sample application area of the testing element, where the area for bearing the sample application area may be in open and closed states.

The area for bearing the sample application area is in the open state to expose the sample application area such that the sample application area of the testing element is in contact with the liquid sample.

In some embodiments, the area for bearing the sample application area is in the open state to expose the sample application area such that the sample application area of the testing element is inserted into the container containing the liquid sample.

In some embodiments, the area includes one or more elements capable of being opened; the sample application area of the testing element is wrapped or covered by the element; when the element is opened, the sample application area of the testing element is inserted into the container containing the liquid sample and the opened element is located around the container to make the housing standing vertically such that the testing element is inserted into the container in a vertical way.

In some embodiments, the testing element, or the sample application area of the testing element is drawn out of the container. In some embodiments, the drawing way refers that the sample application area is driven by the housing to leave the container containing the liquid sample.

In some embodiments, the opened element is closed after the sample application area leaves the container containing the liquid sample such that the sample application area of the testing element is wrapped by the element again or covered on a space formed by closing the element.

In some embodiments, there are two elements which may be opened or closed after being opened; the two elements are located at both sides of the sample application area, separately when opened.

In some embodiments, bonding elements are disposed at tail ends of the two elements such that the two elements may be opened easily and bound together easily when assembled. In some embodiments, the bonding element includes a buckle, magnetic adsorption, a magnet and the like.

Beneficial Effects

The use of the above structure may reduce the cost of rapid diagnosis. If a paper material is used as a buckle bearing a sample and the sample is not applied with a water dropper, but the carrier is opened directly, and the area of the testing element contacts liquid to achieve detection. Therefore, the present invention is more suitable for household detection and omits tedious steps, thus achieving simpler and more convenient operation.

### BRIEF DESCRIPTION OF THE DRAWINGS

FIG. 1 is an expanded diagram showing a housing of a test device in a detailed embodiment of the present invention.

FIG. 2 is a folded diagram showing an housing in a detailed embodiment of the present invention.

FIG. 3 shows a folded diagram showing an housing in another detailed embodiment of the present invention.

FIG. 4 is a schematic diagram showing a structure with a testing element after the housing is folded in a detailed embodiment of the present invention.

FIG. 5 is a schematic diagram showing an open state of a test device for reading to process the testing, like inserting the sample area of the test element into the liquid sample.

FIG. 6 is a schematic diagram showing a structure that housing is opened for detection in a detailed embodiment of the present invention.

FIG. 7 is a schematic diagram showing a structure that an housing is opened for detection in a detailed embodiment of the present invention.

FIG. 8 is a schematic diagram showing a structure that an housing is opened for detection in a detailed embodiment of the present invention.

FIG. 9 is a schematic diagram showing an expanded structure of the housing or the carrier in a detailed embodiment of the present invention.

FIG. 10 is a structure diagram showing a folding process of the carrier in a detailed embodiment of the present invention.

FIG. 11 is a structure diagram showing that the testing element is put to the carrier during the folding process in a detailed embodiment of the present invention.

FIG. 12 is a structure diagram showing that a test device is assembled in a detailed embodiment of the present invention.

FIG. 13 is a schematic diagram showing that a test device is in an open state before detection in a detailed embodiment of the present invention (movable areas 203,205 overturns to cover on a window area and a supporting area separately).

FIG. 14 is a diagram showing a structural state that a receiving device is subjected to detection in a detailed embodiment of the present invention.

FIG. 15 is a diagram showing a structural state that a receiving device is subjected to detection in a detailed embodiment of the present invention.

FIG. 16 is a structure diagram of a test device (expanded) in a detailed embodiment of the

present invention.

FIG. 17 is a schematic diagram showing an expanded structure of a test device in another detailed embodiment of the present invention.

FIG. 18 is a structure diagram showing a test device during the folding process in another embodiment of the present invention;

FIG. 19 shows an expanded structure before being folded in another embodiment of the present invention.

FIG. 20 is a schematic diagram showing an expanded structure of the foldable carrier in a detailed embodiment of the present invention;

FIG. 21 is a schematic diagram showing an expanded structure of the foldable carrier in another detailed embodiment of the present invention;

FIG. 22 is a schematic diagram showing a closed test carrier (top view);

FIG. 23 is a schematic diagram showing an initial state of the carrier with the testing element in an example of the present invention.

FIG. 24 is a schematic diagram showing an expanded state of the carrier as shown in FIG. 22.

FIG. 25 is a schematic perspective diagram showing an expanded state of the test device as shown in FIG. 24.

FIG. 26 is a schematic perspective diagram showing a test element (lateral flow test strip).

### DETAILED DESCRIPTION OF THE INVENTION

The structures or technical terms used in the present invention are further described in the following. Unless otherwise indicated, they are understood or interpreted according to ordinary terms and definitions in the art.

Detection

Detection denotes assaying or testing whether a substance or material exists, for example, but

not limited to, chemicals, organic compounds, inorganic compounds, metabolites, drugs or drug metabolites, organic tissues or metabolites of organic tissues, nucleic acid, proteins or polymers. Moreover, detection denotes testing the number of a substance or material. Further, assay also denotes immunoassay, chemical detection, enzyme detection and the like.

Samples

The samples that can be detected by the test device of the present invention include biological

liquid (e.g. case liquid or clinical samples). Liquid samples or fluid specimens may be derived from solid or semi-solid samples, including excreta, biological tissues and food samples. Solid or semi-solid samples are transformed into liquid samples by any proper method, for example, mixed, mashed, macerated, incubated, dissolved into a proper solution (for example, water, phosphate solution or other buffer solutions), and solid samples are digested by zymolysis. “Biological samples” include samples from animals, plants and food, for example, including urine, saliva, blood and components thereof, spinal fluid, vaginal secretion, semen, faeces, sweat, secreta, tissues, organs, tumors, cultures of tissues and organs, cell culture and medium from human or animals. The preferred biological sample is urine, preferably, the biological sample is saliva. Food samples include substances processed from food, final products, meat, cheese, wine, milk and drinking water. Plant samples are derived from any plants, plant tissues, plant cell cultures and media. “Environmental samples” are derived from the environment (for example, liquid samples, wastewater samples, soil texture samples, underground water, seawater and effluent samples from lakes and other water bodies). Environmental samples may further include sewage or other waste water.

The suitable test device of the present invention may be used to detect any analyte. Preferably, the present invention is utilized to detect small molecules of drugs in saliva and urine. Of course, any form of samples, either initially solid or liquid, can be detected by the test device in the present invention, as long as these liquid or liquid samples can be absorbed by the sample application area of the testing element. The sample application area here is generally prepared from a water absorbent material. It can absorb liquid or fluid specimens by capillary or other characteristics of the absorbing element material such that liquid samples flow in the sample application area. The material of the sample application area of liquid samples can be any liquid absorbing material such as sponge, filter paper, polyester fiber, gel, non-woven fabric, cotton, polyester film, yarn, etc. Of course, the sample application area of fluid samples is not necessarily prepared by an absorbent material but may be prepared by a non-water absorbent material. But the absorbing element has pores, threads, and cavities, and samples may be collected on these structures. These samples are generally solid or semi-solid samples, and are filled between threads, or in cavities or holes, thus collecting the samples. Of course, optionally, the sample application area of liquid samples may consist of some non-water absorbent fibers and hairs; these materials are used to scratch solid, semi-solid or liquid samples such that these samples are maintained on the sample application area of liquid samples. In need of detection, a buffer solution is added to the sample application area to dissolve the sample such that the dissolved sample flows on the testing element or detecting element.

In some embodiments, the fluid sample is not manually applied onto the sample application area of the testing element in the present invention, but the sample application area may be directly inserted into the fluid sample; the sample application area may be directly taken out or removed after being inserted, and also may be kept in the fluid sample until the completion of the test. During the process, the sample application area is kept upright by means of own structure without manual help. It will be further described in detail with reference to detailed examples below.

Downstream and Upstream

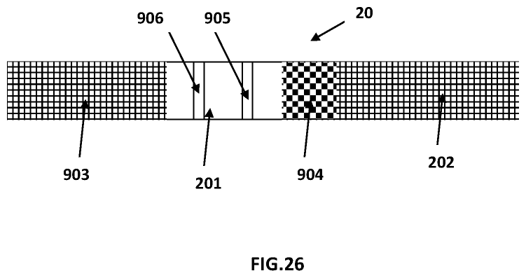

Downstream or upstream is divided according to a flow direction of a liquid, generally, a liquid or fluid flows to a downstream area from an upstream area. The downstream area receives the liquid from the upstream area, and a liquid also may flow to a downstream area along an upstream area. Here, downstream or upstream is generally divided according to a flow direction of a liquid, for example, on some materials where capillary force is utilized to promote the flow of a liquid, a liquid may overcome gravity to flow towards an opposite direction to the gravity; and at this time, downstream or upstream is divided according to a flow direction of the liquid. For example, in the test device 10 of the present invention, after the testing element 20 absorbs fluid samples or liquid samples, the fluid can flow from the sample application area 202 of the testing element to the test area 201 of the testing element 20. At this time, the liquid flow from the sample application area 202 to the test area 201 is flow from the upstream to the downstream. During the flow, the test area 201 has a detecting area 905 and a detecting result control area 906. The test area may be a polyester fiber film and the sample application area may be a glass fiber. At this time, the sample application area or absorbing area 202 is located at the upstream of the test area of the testing element. The specific structure of the testing element is shown in FIG. 26.

Gas Communication or Liquid Communication

Gas flow or liquid flow means that liquid or gas can flow from one place to another place. The flow process may pass through some physical structures, to play a guiding role. The “passing through some physical structures” here means that liquid passes through the surface of these physical structures or their internal space and flows to another place passively or actively, where passivity is usually caused by external forces, such as the flow of the capillary action and air pressure action. The flow here may also be a flow due to self-action (gravity or pressure) of the liquid or gas, and also may be a passive flow. The fluid under the action of air pressure may be a forward flow, or also a reverse flow; or a fluid is urged to flow to another position from a position under the action of air pressure. Here, the flow does not mean that a liquid or a gas is necessarily present, but indicates a relationship or state between two objects under some circumstances. In case of presence of liquid, it can flow from one object to another. Here it means the state in which two objects are connected. In contrast, if there exists no gas flow or liquid flow state between two objects, and liquid exists in or above one object but cannot flow into or on another object, it is a non-flow, non-liquid or non-gas flow state.

Testing Element

The “testing element” used herein refers to an element that can be used to detect whether a fluid specimen or a fluid sample (a liquid specimen or a liquid sample) contains an interested analyte. Such testing can be based on any technical principles, such as immunology, chemistry, electricity, optics, molecular science, nucleic acids, physics, etc. The testing element can be a lateral flow test strip that can detect a variety of analytes. Of course, other suitable testing elements can also be used in the present invention.

Various testing elements can be combined for use in the present invention. One form of the testing elements is test paper. The test papers used for analyzing the analyte (such as drugs or metabolites that show physical conditions) in samples can be of various forms such as immunoassay or chemical analysis. The analysis mode of non-competition law or competition law can be adopted for test papers. A test paper generally contains a water absorbent material that has a sample application area, a reagent area and a test area. Fluid or liquid samples are added to the sample application area and flow to the reagent area through capillary action. If analyte exists in the reagent area, samples will bind to the reagent. Then, samples continue to flow to the test area. Other reagents such as molecules that specifically bind to analyte are fixed in the test area. These reagents react with the analyte (if any) in the sample and bind to the analyte in this area, or bind to a reagent in the reagent area. A marker used to display the detection signal exists in the reagent area or the detached labeled area.

Typical non-competition law analysis mode: if a sample contains analyte, a signal will be generated; and if not, no signal will be generated. Competition law: if no analyte exists in the sample, a signal will be generated; and if analyte exists, no signal will be generated.

The testing element can be a test paper, which can be water absorbent or non-absorbing materials. The test paper can contain several materials used for delivery of liquid samples. One material can cover the other material. For example, the filter paper covers the nitrocellulose membrane. One area of the test paper can be of one or more materials, and the other area uses one or more other different materials. The test paper can stick to a certain support or on a hard surface for improving the strength of holding the test paper.

Analyte is detected through the signal generating system. For example, one or more enzymes that specifically react with this analyte is or are used, and the above method of fixing the specifically bound substance on the test paper is used to fix the combination of one or more signal generating systems in the analyte testing area of the test paper. The substance that generates a signal can be in the sample application area, the reagent area or the testing area, or on the whole test paper and one or more materials of the test paper can be filled with this substance. The solution containing a signifier is added onto the surface of the test paper, or one or more materials of the test paper is or are immersed in a signifier-containing solution; and the test paper containing the signifier solution is made dry.

Each area of the test paper can be arranged in the following way: sample application area 202, reagent area, test area 201, control area, area determining whether the sample is adulterated, and liquid sample absorbing area. The control area or control line 906 is located behind the test area or the test line 905. All areas can be arranged on a test paper that is only made of one material. Also, different areas may be made of different materials. Each area can directly contact the liquid sample, or different areas are arranged according to the flow direction of liquid sample; and a tail end of each area is connected and overlapped with the front end of the other area. Materials used can be those with good water absorption such as filter papers, glass fibers or nitrocellulose membranes. The test paper can also be in the other forms.

The nitrocellulose membrane test strip is commonly used, that is, the test area includes a

nitrocellulose membrane (NC) on which a specific binding molecule is fixed to display the detecting result; and other test strips such as cellulose acetate membrane or nylon membrane test strips can also be used. For example, the test strips and similar apparatuses with test strips disclosed in the following patents can be applied to the testing elements or test devices in this invention for analyte detection, such as the detection of the analyte in the samples: U.S. Pat. Nos. 4,857,453; 5,073,484; 5,119,831; 5,185,127; 5,275,785; 5,416,000; 5,504,013; 5,602,040; 5,622,871; 5,654,162; 5,656,503; 5,686,315; 5,766,961; 5,770,460; 5,916,815; 5,976,895; 6,2485,98; 6,140,136; 6,187,269; 6,187,598; 6,228,660; 6,235,241; 6,306,642; 6,352,862; 6,372,515; 6,379,620, and 6,403,383. The test strips and similar device provided with a test strip disclosed in the above patent literatures may be applied in the testing element or test device of the present invention for the detection of an analyte, for example, the detection of an analyte in a sample.

The test strips used in the present invention may be those what we commonly called lateral flow test strip, whose specific structure and detection principle are well known by those with ordinary skill in the art. Common test strip (FIG. 26) includes a sample collecting area or a sample application area 202, a labeled area 904, a test area 201 and a water absorbing area 903; the sample collecting area includes a sample receiving pad, the labeled area includes a labeled pad, the water absorbing area may include a water absorbing pad; where the test area includes necessary chemical substances for detecting the presence or absence of analyte, such as immunoreagents or enzyme chemical reagents. The nitrocellulose membrane test strip is commonly used, that is, the test area 201 includes a nitrocellulose membrane on which specific binding molecule is fixed to display the detecting result area; and other test strips such as cellulose acetate membrane or nylon membrane test strips can also be used. Of course, in the downstream of the test area, there may also be a detecting result control area; generally, test strips appear on the control area and the test area in the form of a horizontal line, that is a detection line 905 or a control line 906, and such test strips are conventional. Of course, they can also be other types of test strips using capillary action for detection. In addition, there are often dry chemical reagent components on the test strip, for example immobilized antibody or other reagents. When the test strip meets liquid, the liquid flows along the test strip with the capillary action, and the dry reagent components are dissolved in the liquid, then the liquid flows to the next area, the dry reagents are treated and reacted for necessary detection. The liquid flow mainly relies on the capillary action. Here, all of them can be applied to the test device of the present invention or can be disposed in contact with the liquid samples in the test chamber or used to detect the presence or absence of analyte in the liquid samples that flow into the test chamber, or the quantity thereof.

In addition to the foregoing test strip or lateral flow test strip which is used to contact with the liquid to test whether the liquid samples contain analytes, the testing element of the present invention may be used as a test device by itself to detect an analyte in a sample. Therefore, the test device here is equal to a testing element. For example, after being mixed with the treatment solution, the fluid sample is detected with a testing element directly, specifically described as follows: when the receiving device is described to treat a fluid sample, the testing element may be used for detection alone.

Analyte

Examples that can use the analyte related to this invention include small-molecule substance, including drugs (such as drug abuse). “Drug of Abuse”(DOA) refers to using a drug (playing a role of paralyzing the nerves usually) not directed to a medical purpose. Abuse of these drugs will lead to physical and mental damage, produce dependency, addiction and/or death. Examples of DOA include cocaine, amphetamine AMP (for example, Black Beauty, white amphetamine table, dextroamphetamine, dextroamphetamine tablet, and Beans); methylamphetamine MET (crank, methamphetamine, crystal, speed); barbiturate BAR (e.g., Valium [symbol] , Roche Pharmaceuticals, Nutley, and New Jersey); sedative (namely, sleep adjuvants); lysergic acid diethylamide (LSD); depressor (downers, goofballs, barbs, blue devils, yellow jackets, methaqualone), tricyclic antidepressants (TCA, namely, imipramine, Amitryptyline and Doxepin); methylene dioxymetham-phetamine (MDMA); phencyclidine (PCP); tetrahydrocannabinol (THC, pot, dope, hash, weed, and the like). Opiates (namely, morphine MOP or, opium, cocaine COC; heroin, oxycodone hydrochloride); antianxietics and sedative hypnotics, antianxietics are drugs for alleviating anxiety, tension, fear, stabilizing emotion and having hypnosis and sedation, including benzodiazepines (BZO), non-typical BZs, fusion dinitrogen NB23Cs, benzoazepines, ligands of a BZ receptor, open-loop BZs, diphenylmethane derivatives, piperazine carboxylates, piperidine carboxylates, quinazoline ketones, thiazine and thiazole derivatives, other heterocyclic, imidazole sedatives/analgesics (e.g., oxycodone hydrochloride OXY, metadon MTD), propylene glycol derivatives, mephenesin carbamates, aliphatic compounds, anthracene derivatives, and the like. The test device of the present invention may be also used for detecting drugs which belong to medical use but is easy to be taken excessively, such as tricyclic antidepressants (Imipramine or analogues), acetaminophen and the like. These medicines will be resolved into micromolecular substances after being absorbed by human body, and these micromolecular substances will exist in blood, urine, saliva, sweat and other body fluids or in some of the body fluids.

For example, the analyte detected by the present invention includes but not limited to creatinine, bilirubin, nitrite, proteins (nonspecific), hormones (for example, human chorionic gonadotropin, progesterone, follicle-stimulating hormone, etc.), blood, leucocyte, sugar, heavy metals or toxins, bacterial substances (such as, proteins or carbohydrates against specific bacteria, for example, Escherichia coli. 0157:H7, Staphylococcus, Salmonella, Fusiformis genus, Camyplobacter genus, L. monocytogenes, Vibrio, or Bacillus cereus) and substances associated with physiological features in a urine sample, such as, pH and specific gravity. The chemical analysis of any other clinical urine may be conducted by means of a lateral cross-flow detection way and in combination with the device of the present invention.

Carrier Element

In some detailed embodiments, the testing element may be also disposed on some carrier elements; then the carrier elements contain the testing element therein to complete the detection and assay of the analytes in fluid samples. Therefore, in some embodiments, the test device includes a carrier, and the carrier is provided with a testing element. In some embodiments, the carrier of the present invention is a housing used for bearing or accommodating the testing element terein; the carrier element does not participate in the detection directly by itself, but serves as a carrier or a housing used for bearing or accommodating the testing element. In some embodiments, the housing or carrier of the present invention includes a trough structure, and the structure is used for limiting the position of the testing element on the carrier. One or more trough structures here may be available. Each trough body is provided with a testing element, and the testing element may be used for testing the number or presence of analytes in a sample.

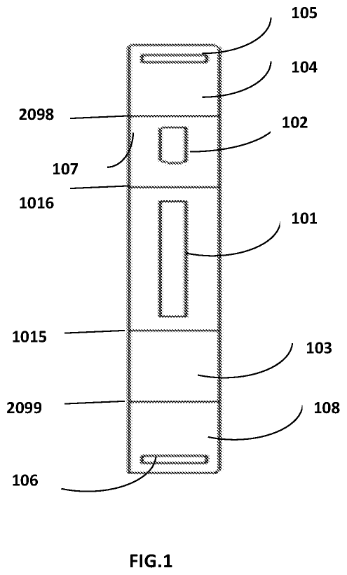

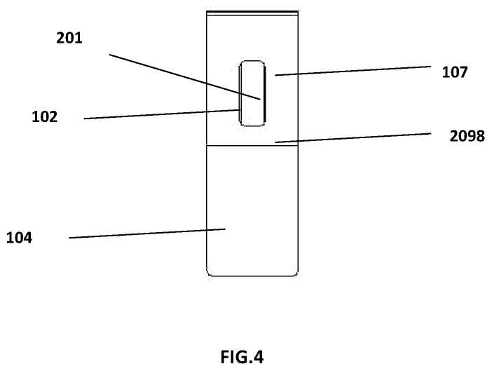

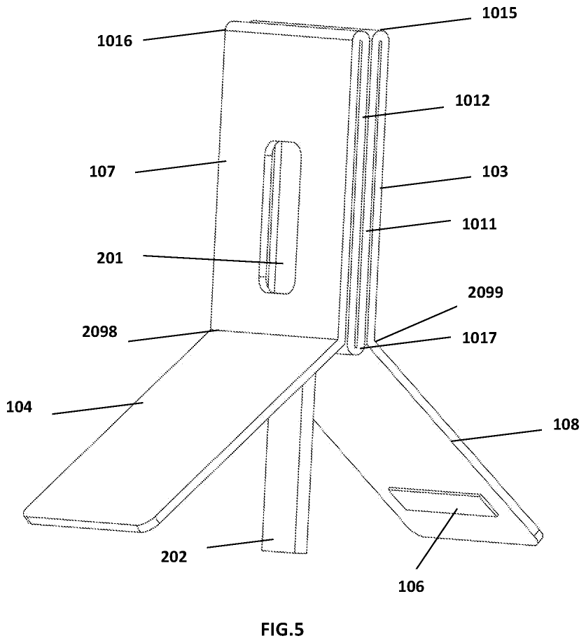

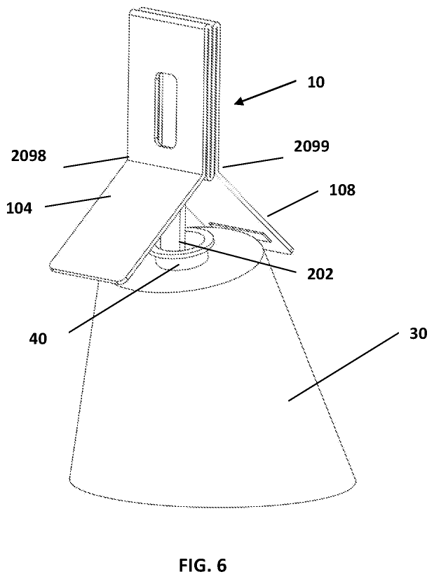

In some embodiments, as shown in FIG. 1-5, a test device 10 includes a testing element 20; the test device includes a window area 102 used for showing the test area 201 of the testing element 20; the window area may be a transparent area such that the test result on the test area 201 may be read through the window area 102. In some embodiments, the window area may be covered with a transparent film. The test device further includes a movable area; the movable area may be in an open or closed state; in case of being in the closed state, the movable area covers the testing element in the housing, and mainly covers or protects the sample application area of the testing element; in case of being in the open state, the testing element is exposed, especially, the sample application area of the testing element is exposed for contacting liquid samples, thus finishing the detection. As shown FIGS. 4-5, FIG. 4 shows a closed state, and FIG. 5 shows an open state. In some embodiments, the movable area or the open area includes one or two movable elements; the movable elements are in flexible connection with a portion of the housing via a fold line 2098 or 2099, or in flexible connection with the housing in a hinged form. The carrier or the housing is divided into two areas by the fold line 2098 and the fold line 2099; one is a movable area and covers the sample application area 202 of the testing element that can be closed or opened, and another area is a non-movable area or non opened area; the non-movable or non-opened area mainly includes a window 102 for reading the test result; the window is corresponding to the test area 201 of the testing element; the position of the test area is generally kept fixed in the non-opened area. In some embodiments, the no-opened area also may include the label area that is fixed in this area. The reasons is that some reagent is pre-treated in or on the test area and in the label area that can have the function to test a analyte in the liquid sample. In some embodiments, as shown FIG. 5, the movable area includes two movable elements (104, 108); the testing element, in particular to the sample application area of the testing element, is disposed between the two movable elements. When the two movable elements are closed, the sample application area of the testing element is protected; in case of being in the open state, the sample application area is exposed. To make the two movable elements bound more closely when closed, elements capable of being bound together are stick on internal areas at the end of the movable elements 104,108; the bonding elements may make the two movable elements separated or closed when in need. In need of detection, the sample application area 202 of the testing element is in direct contact with the liquid sample; for example, as shown FIG. 6, the sample application area 202 of the testing element 20 is directly inserted into a test tube 40 which collects fluid samples. At this time, the opened movable elements 104 and 108 play a role of holders such that the whole testing element is standing around the test tube. As shown in FIG. 6, the test tube is located on a test tube stand 30, and the test tube stand has a test tube 40 such that the test device is kept standing on the test tube stand by the two opened elements 104 and 108 and the sample application area is allowed to contact with the liquid sample directly for liquid flow. Such a test way may be implemented directly. At the end of the detection or the test is finished, the test result is displayed on the test area 201 of the testing element; the test result on the testing element is read through the transparent window area 102. After reading the test result, the whole test device may be removed from the test tube, for example, the housing is removed from the test tube directly by holding the portion of the test area 107 on the housing, for example, the position indicated by 107. The separated movable elements 104,108 are then combined together and bound together again via the bonding elements. In this way, the carrier may achieve detection by itself once being kept standing; moreover, the carrier is made of paper, for example, a degradable paper material, which is convenient for treatment and free of environmental pollution. Furthermore, the carrier may be kept standing for detection itself by relying on own structure without other structures, which is thus not in need of special management. In this way, detection on a plurality of different samples may be implemented for one time. Moreover, the present invention omits the conventional step of applying samples by absorbing samples with a water dropper and then drop wisely adding onto a test card with liquid addition holes. Such a novel test of the present invention is more suitable for household detection. Moreover, the test card is light and convenient and thus, is more suitable for own detection demands.

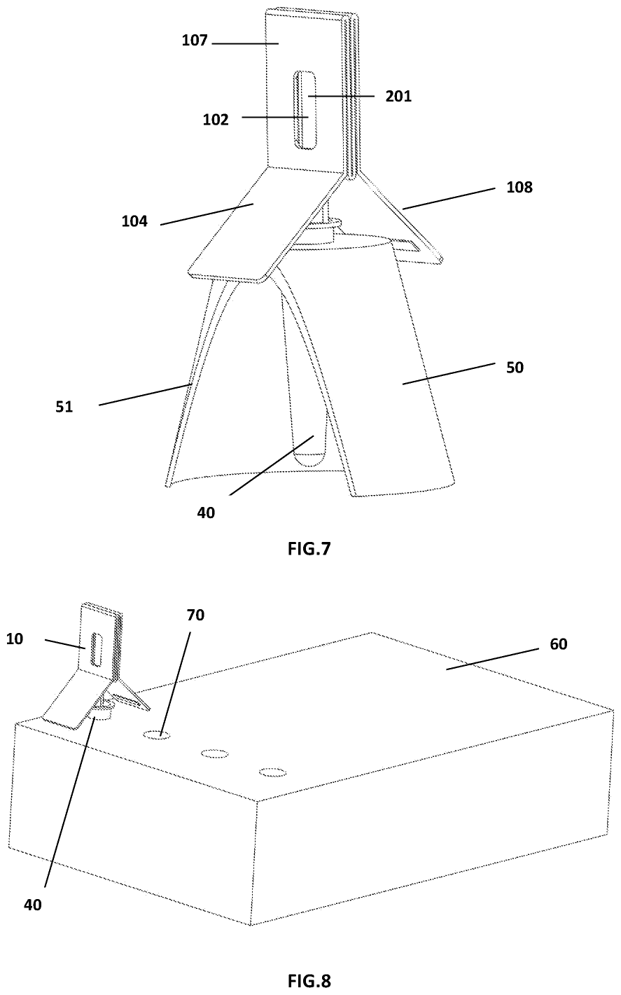

In some embodiments, the test tube has a standing structure by itself. As shown in FIG. 7, the test tube includes a tube body and structures (50, 51) for supporting the tube body such that the test tube stands on a bench by itself. During the detection, as shown in FIG. 6, the test device is directly used as a support via the opened elements to stand on the test tube, and the opened elements 104,108 are directly supported on the test tube stand. Due to supporting functions, the test device is in a vertical posture, which is convenient for detection and reading test results.

In some embodiments, the device has a packaging box 60; the packaging box has an insertion hole 70 such that the test tube is inserted. At this time, the application area 202 of the testing element in the test device is directly inserted into the test tube; the opened elements 104 and 108 allow the test device to stand on the box body. The box body of the present invention may be further a packaging box in UK and European applications, as described in UK application number 6191823 and European application number 008867121. The packaging box described herein may be used for storing the test device 10 or 200 of the present invention.

In some embodiments, the housing of the test device of the present invention is not just like a traditional plastic housing; all the traditional plastic housings include upper and lower face plates; the face plates have trough structures such that the testing element is located in the housing, for example, as described in European patent application EP2120048A1, US patent application US20070287198A1 and PCT patent application WO2013096804A2, the test device includes upper and lower face plates, and is formed by mold injection molding, and then the testing element is placed into the two face plates, thus being integrated into the housing. The housing of the present invention is formed by folding a card. Firstly, the folding process is very simple and requires no a mold for injection molding. The folding of a paper or paper card omits the injection molding process, which not only reduces the production cost, but also greatly reduces the adverse impacts of plastic degradation and disposal on the environment. Moreover, when a card made of a paper material is folded to form the housing, the weight is also greatly reduced to save the transportation cost. When the paper is biodegradable, compared with plastic, the paper device greatly decreases environmental pollution.

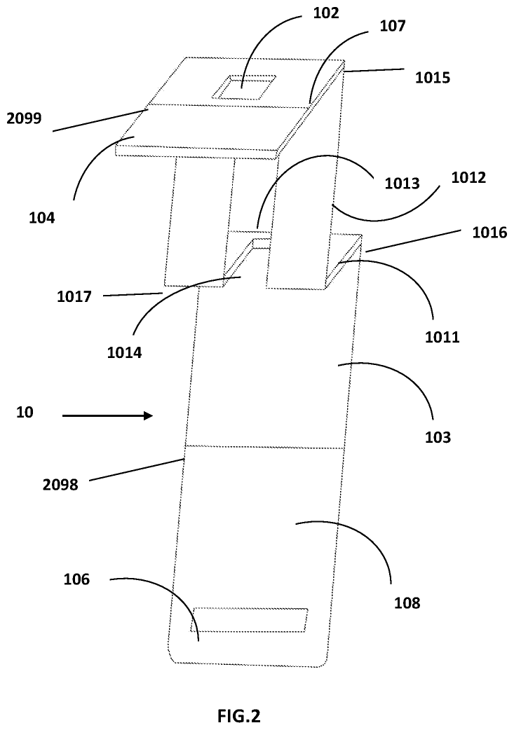

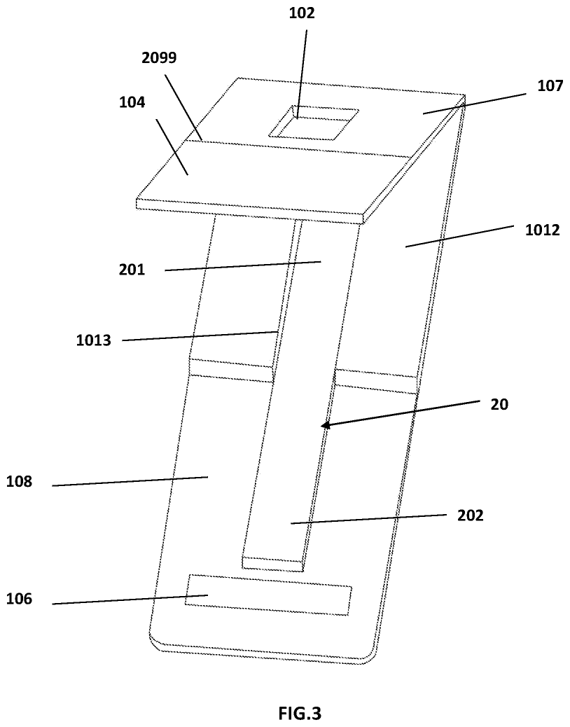

Therefore, in some embodiments, the housing of the test device of the present invention is formed by folding an integral paper card. FIGS. 1-4 show a complete folding process of a card which will be introduced in detail below. For example, FIG. 1 is an embodiment showing the expansion of the housing, including several areas. These areas are connected via folding or fold lines, and formed by folding the fold lines. Specifically, the card includes movable areas 108 and 104; the movable areas are located at both ends of the card 10; one area connected with the movable area 104 is a window area 107; and the area is provided with a window area 102 used for reading the test result on the test area 201 of the testing element. The position connected with the window area is a slot 101 for placing the testing element 20; the slot area forms a slot structure for placing the testing element via folding; the card has a certain thickness, and the slot area 101 also has the corresponding thickness after being folded, thus accommodating the testing element 20 or matching the thickness of the testing element. For example, when the thickness is 1-3 mm, a single layer of slot area has a thickness of 1-3 mm; if double layers of slot areas are folded, the thickness is 2-6 mm. Generally, the slot 101 of the trough body area is located inside the housing when folded. For example, as shown in FIGS. 2-3, the slot area is folded, namely, folded in the middle position of the slot 101 along the fold line 1017 in half, to form four surfaces and two parts 1011, 1012. One of the two surfaces of the card 1011 contacts with the surface 103 and located above the front surface of the part 103, and the other surface of the card 1011 is contracted with the back surface of the car 1012, or covers on the surface 1011. In this way, the slot is folded to form a slot structure 1013, and the slot 101 or two surfaces 1011,1012 are folded to form a slot of the testing element; the surface 103 as the bottom surface contacts with the back of the test strip such that the test strip is located in the housing stably. The folded surfaces may be bound together via an adhesive, for example, glue, and the like.

In some embodiments, the folded slot 101 is mainly used for accommodating the test area 201 of the testing element or an water absorbing area 903 downstream of the test area; of course, if the folded slot 101 is long enough, a labeled area 904 may be accommodated. Antibodies, antigen reagents, and the like necessary to the detection are treated on the test area and the labeled area in the whole testing element, and these components are preferably kept in a fixed position and protected. In such a folding way, the portion with a window 102 covers on the test area 201 to expose the test area 201. The folded slot 101 is divided into two overlapped slot structures 1013 and 1014. After being folded, the slot area 101 is located on the surface 103. In this way, the surface 103 and slot opening 101 form an integrated slot structure for fixing the testing element therein. The surface 103 may be called a supporting face used for binding with the slot to support the testing element. In some embodiments, the length of the slot opening 101 in the slot area after being folded is generally greater than the test area of the testing element, for example, when the testing element also has an absorbing area, the test area 201 and the absorbing area of the testing element are located in the slot. For example, the length of 1014 may accommodate the test area 201 and the absorbing area of the testing element 20 or the labeled area. The length of the window 102 covering on the trough body only shows the test area 201, thus exposing the window area (as shown in FIG. 4). In the aspect of the size of each area, card is generally rectangular, and the width of each area is kept consistent. The length of the movables areas 108 and 104 is the same. The length of the supporting face 103 is equal to the length of the face of the slot area 1013 (folded). Here the length of the slot area after being folded is roughly equal to the length of the surface 103. When the slot area need not be folded, the length of the slot area is equal to the length of the supporting face. In this way, a symmetric test device is formed. The movable area 104 connected to the window and the card portion 108 connected to the surface 103 are mainly used for supporting the sample application area of the testing element. In the initial first closed state and second expanded or open state, the sample application area of the testing element is located in the exposed or protected state, which may be in contact with the liquid sample, thus achieving detection. Therefore, the movables areas are provided with the absorbing area of the testing element or an area 202 in contact with liquid samples.

The movables area 108 or 104 is provided with a functional structure which allows the two movables areas to be bound. The structure may render the movables areas to be closed, and such a closed function may be removed. The movables area 108 or 104 is allowed to be closed or unfolded according to the requirements such that the sample application area of the testing element is exposed to be in contact with fluid samples. For example, as shown in FIGS. 2-3, the tail end of the movable area 108 has a bonding area 106; the area may make the two movable elements bound together; for example, in one embodiment, the bonding area of the movable 108 has a magnet, and an iron sheet is stick on the area corresponding to another movable 104; the 2 elements are bound together due to mutual attraction when get closed. The two elements are expanded outward and separated when in need of expansion, thus forming the state as shown in FIG. 5. After being folded, positions with a fold line or fold mark can be seen from FIG. 5, namely, a fold mark or fold line 1016 of the window area and slot area 1012, a folding area 1015 of the supporting face area 103 and the slot area, as well as a folding area 1017 formed by folding the slot area in half (inside the two movable areas). The two movables areas 104 and 108 are folded with the corresponding areas via folding areas 2099 and 2098, thus being in open and closed states. It may be understood that the sample application area of the testing element is only located between the expanded areas 108,104, while other areas are bound together closely to form an integrated structure such that the test area of the testing element, the water absorbing area and/or the labeled area are fixed and not exposed.

To make the test device being in an intact assembly state, glue may be coated on the window area 107, the slot areas 1012 and 1011 and the supporting area 103 such that faces of the areas contact and are bonded with each other, but the movables areas are not glued. Of course, to fix the testing element better, the supporting face may be glued such that the testing element is fixed on the supporting face. The portion of the testing element located at the movable areas is not glued such that the movable areas are closed or expanded, thus exposing the sample application area 202 of the testing element.

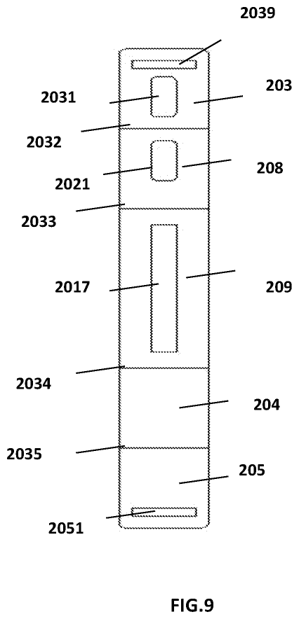

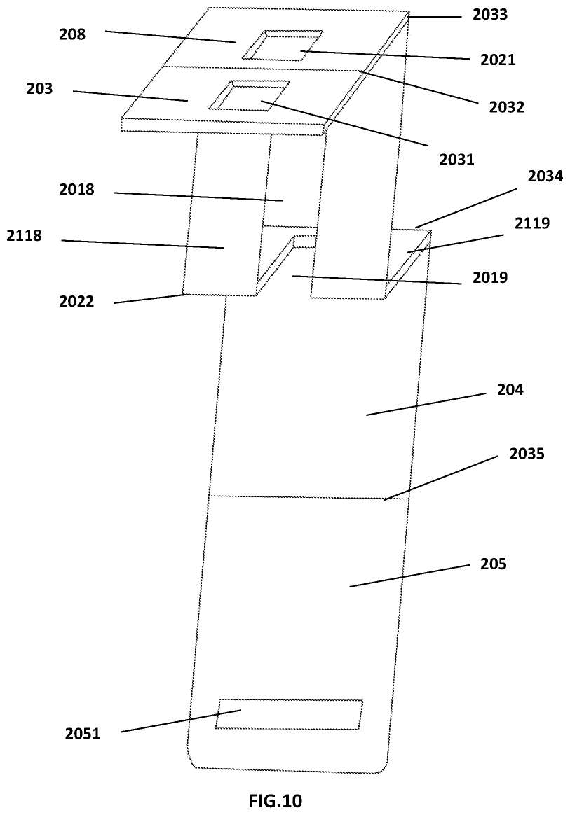

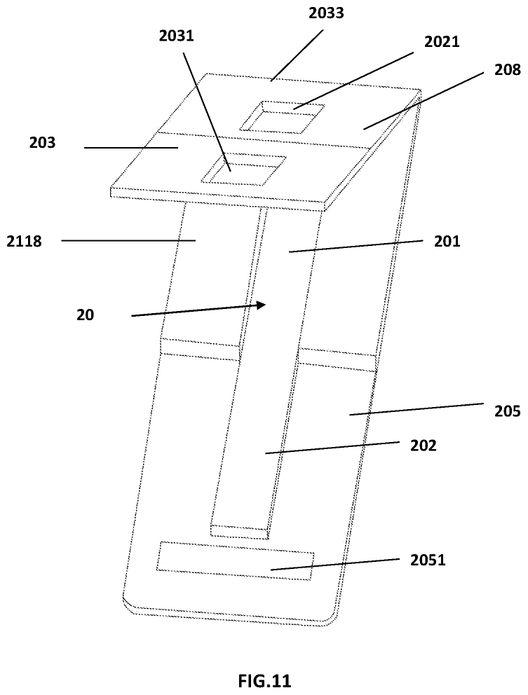

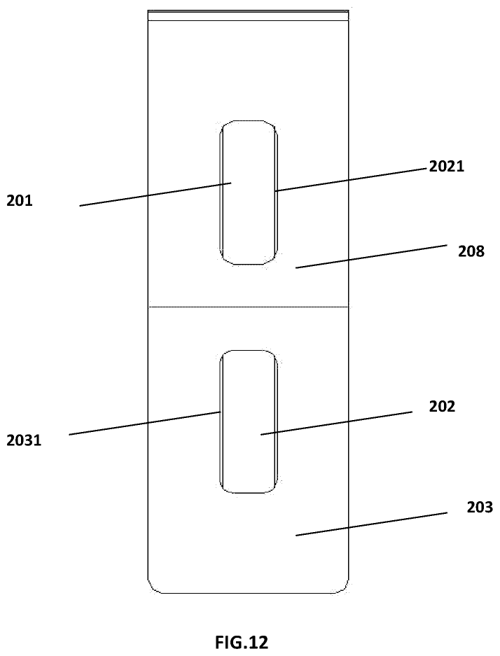

In some other embodiments, a paper card is provided, and the card is provided with a plurality of openings or windows which are folded to form a test card or a test device containing a testing element therein. For example, FIG. 9 shows an expanded view of a paper card; three windows 2031,2021,2017 are configured and located at different areas 203,208,208, separately, where there are fold lines 2032,2033,2034,2035 separated by the three areas. The folding area 209 includes a slot area 2017, the same as that in FIG. 1. The supporting area 204 and the window area 208 include a window 2021, the same as that in FIG. 1. The difference is that one movable area 203 is also provided with a window area 2031 whose size is roughly the same as the window 2021 of the window area 208. The size of the movable area 205 is almost the same as that of the movable area 203; the size here refers to the same length and width of the area such that the movable areas may be completely covered during assembly. The folding way of the slot area is the same as that as shown in FIGS. 1-3, namely, the window 2017 is divided into two symmetric portions by folding along the fold line 2022 inward (FIGS. 10-11), of which one portion 2119 covers on the lower area 204, while another portion 2118 covers on the face as shown in 21119, and the areas 203,208 containing two windows cover on the back of the area as shown in 2118 (FIG. 11). In this way, the testing element 20 is disposed into the slot formed by the combination of the two slots 2018, 2019, for example, the folding way as shown in FIGS. 10-11. At the end of the folding, the sample application area 202 of the testing element is exposed to the window 2031 on the movable area 203, for example, the closed state as shown in FIG. 12. A window 2031 is opened on the movable area 203, which is aimed at allowing the position of the sample application area of the testing element to be seen. During the operation, such configuration may distinguish the window 2021 of the test area from the window of the sample application area.

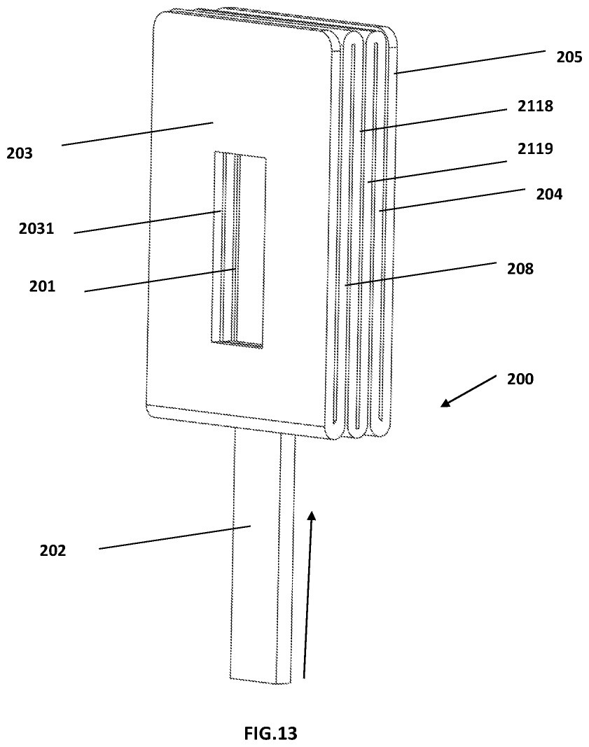

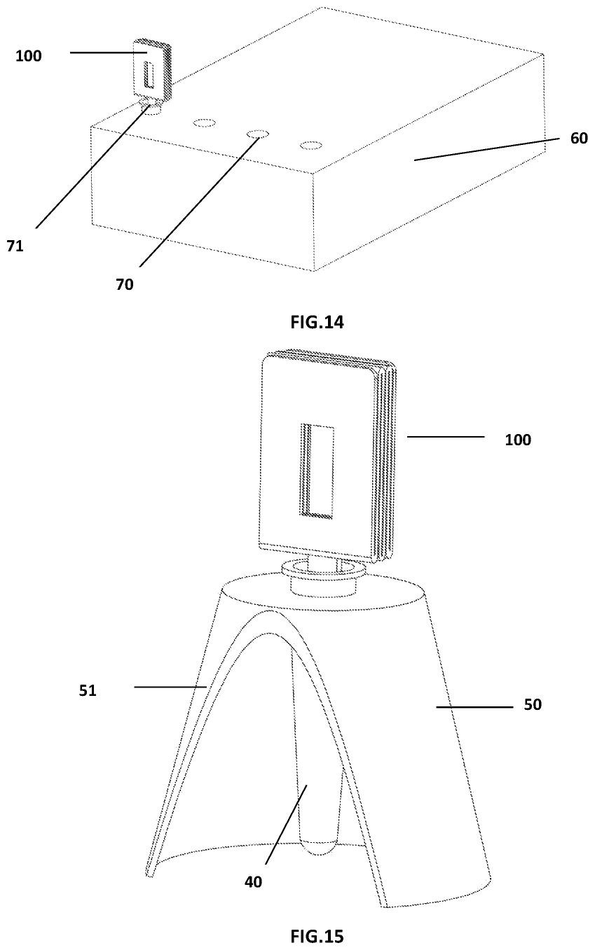

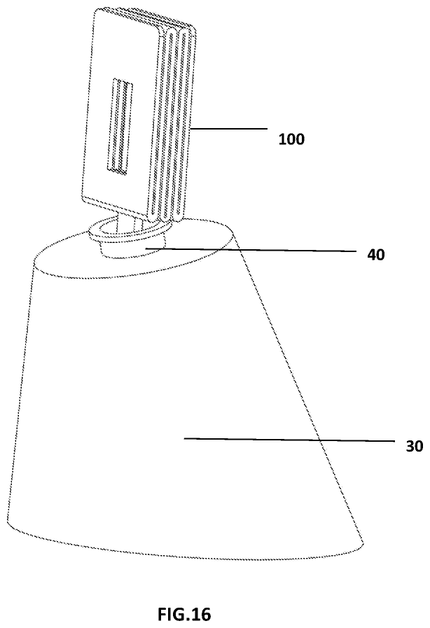

In case of being in the open state, the movable areas 203,205 are folded reversely such that the movable areas cover on the window area 202; and the window 2031 on the movable area 203 is overlapped with the window 2021 on the window area 202. Another movable area 205 is also folded reversely to be back to back with the supporting area 204; and the movable area 205 covers on the supporting area 204 to form a structure as shown in FIG. 13. At this time, the sample application area 202 of the testing element is exposed completely, and an integrity formed by folding the several areas serves as a portion of the housing 200. In need of detection, sample application area 202 of the housing is directly inserted into the test tube or a container with samples such that the sample application area 202 of the testing element contacts with the samples, thus finishing the detection, as shown in FIGS. 14-16. The length of the test areas in the same row may be adjusted freely; moreover, the testing element contains a rigid lining; even if the test strip is inserted into a container with a fluid sample, for example, a test tube, a box body with a test tube, or a test tube stand with a test tube, the test device will be not overturned or upside down due to light weight, but still be kept standing vertically with the same angle as the sample application area of the testing element. Such way is the same as that as shown in FIGS. 6-7. As shown in FIG. 16, the test tube 40 is inserted into a test tube rack by itself; because the test tube rack has an inclined angle, when the sample application area 202 of the testing element is inserted into the test tube, the whole test card (containing a window for reading the test area on the testing element) is standing, but has an inclined angle. Such a configuration is convenient for reading a test result on the test area, particularly suitable for reading a test result by a mobile phone.

The closed or expanded state between the movable areas 203,205 may be achieved without any extra structure such that the movable areas are in a free closed or expanded or open state. However, to protect the testing element therein better, the movable areas are allowed to be in a closed or expanded state via an extra structure. The structure here which allows the movable areas to be in a closed or expanded state may be any structure capable of making two surfaces bonded with each other. The structure is operated to achieve the expanding state of the movable areas when necessary.

Such a structure which allows the movable areas to be in a closed or expanded state may be any achievable structure, for example, a clamping mode, the movable area 108 has openings, and some similar bolts are cut on another movable area 104. In this way, in need of being closed, the bolts are inserted into the openings to form a closed state, and the bolts are formed by cutting on the movable area 104 and located in the same position with the plane of the movable area 104 when not used and hidden in the plane 104. The bolts are exposed when necessary, for example, the cut bolts are kept vertical to achieve the coordination between the bolts and holes, thus achieving the closed state. Of course, a similar snap button may be also arranged on the movable area, and the snap button has a hole, and another movable face 104 is provided with a bolt. In need of being closed, the bolt is directly inserted into the hole to achieve the closed state; in need of being expanded, the bolt is removed from the insertion hole such that the movable area is expanded. In some embodiments, a magnetic piece 106 is pasted on the movable area 108; one paster or one magnetic piece is pasted on another movable area 105. When the movable areas need to be closed, two sides are made close with each other directly to achieve the closed state due to magnetic attraction, in need of being expanded, two movables areas 108 and 104 are allowed to be expanded. In some embodiments, the movable area 205 is allowed to cover on the supporting face 204, and the movable area 203 with a window area 2031 is allowed to cover on the window area 202. In this way, the two movable areas with magnetic attraction 2051,2039 are made close with each other such that two faces are close together with attraction, and each face covered is not easy to get back into shape at least, as shown in FIG. 13, they are always in the covered state in the following operation process free of deformation, for example, free of returning to the expanded state (as show in FIG. 5).

In some embodiments, the movable area 108 and another movable face 104 are pasted with N paster, and the N paster may also achieve free closed or expanded state.

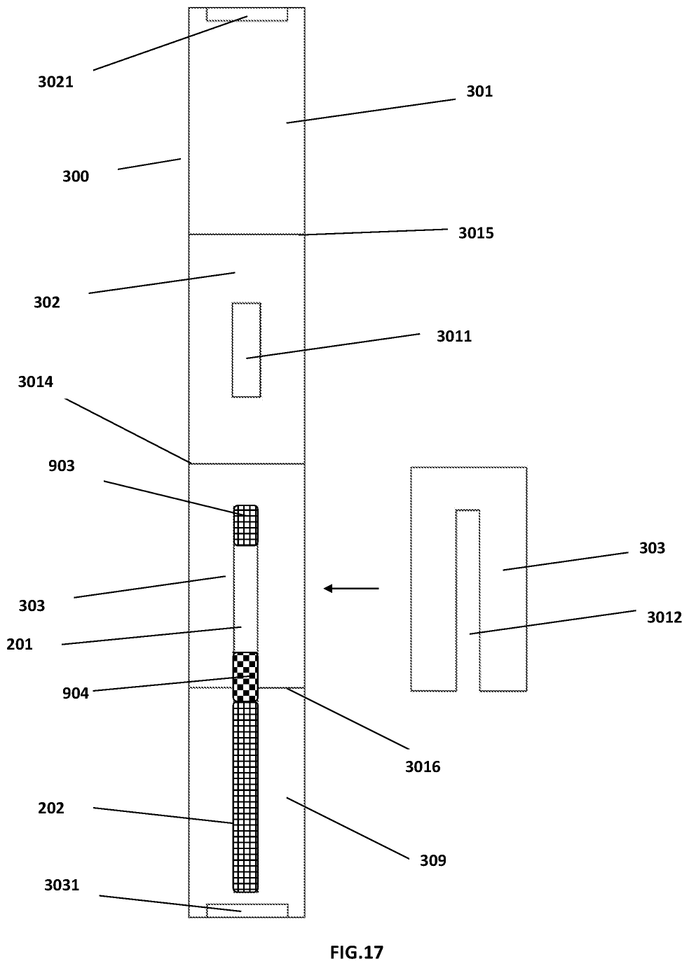

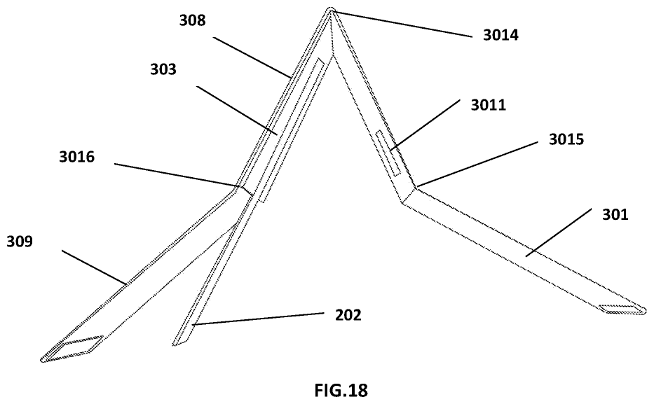

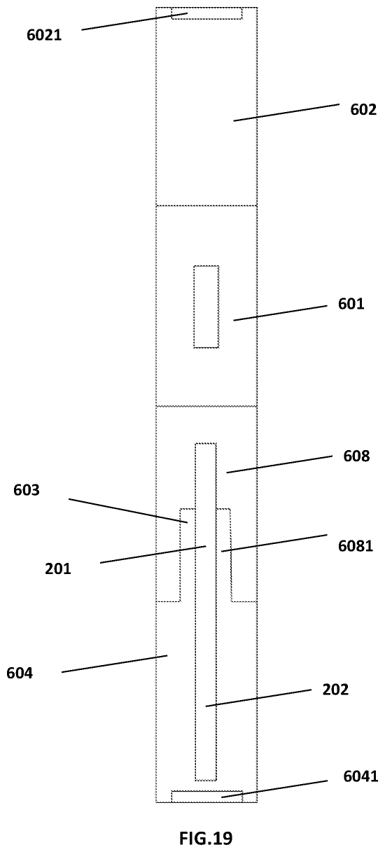

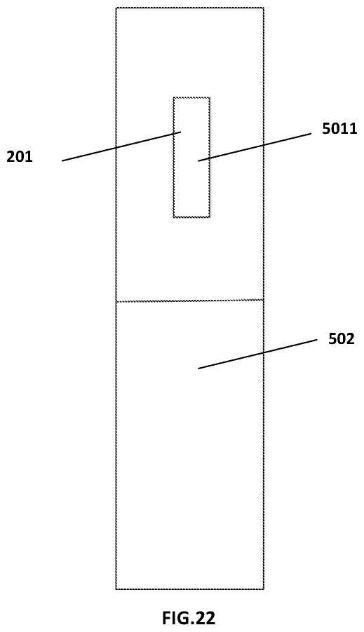

In another detailed embodiment, for example, as shown in FIGS. 17-19, a paper card 300 is also provided, and the card is provided with several areas, movable areas 301 and 309, and a window area 302 which has a transparent area 3011 on the test area 201 for reading or displaying the testing area of the test element 20. The supporting area 308 is directly pasted or banded or fixed with a thin paper 303 with a trough body or slot 3012, and the paper card has certain length; the thickness of the slot 3012 opened is equivalent to the thickness of the testing element 20, thus forming a slot for fixing the testing element. The slot area here is formed by pasting relying the supporting area 308 and the thin paper 303 with a trough body without folding. The test area of the testing element is located at the slot area. Magnetic pieces 3021 and 3031 are pasted at both ends of the movable areas 301 and 309 such that the two movable pieces may be closed or opened, or the movable piece 301 overturns to cover on the back face of the supporting face 308, and the movable face 309 overturns to cover on the window area 302, and at this time, the movable face 301 may be provided with a window (not shown). By such a configuration, the card is folded in half along the fold line 3014 disposed therein to form the test card as shown in the left of FIG. 22. Such a way is simpler relative to the foregoing multi-folding way. Even though the thickness of the paper card increases, mass production and processing becomes simpler, and a plurality of slot-carrying paper sheets may be pasted on the paper card in a length automatically to fix the testing element, and then the testing element may be automatically disposed on the slot 3012 and cut into individual test units by a machine (as shown in the left of FIG. 19). Similar to the foregoing test device, the slot is mainly used to fix test area 201 of the testing element, the water absorbing area 903 or labeled area 904 downstream of the test area, while the sample application area 202 of the testing element is not located in the slot but located between the movable areas 309,301. Of course, the thin paper 303 with a trough body is bound to the window area 302 and the supporting area 308 via glue to form an inseparable area. The test card is divided into two parts by fold lines 3015,3016; one is the inseparable portion containing the test area 201, and another one is the separable area which contains the movable elements 301,309, and is connected to the test area via fold lines 3015,3016, and may be folded. In need of detection, the movables areas 302,304 of the test card are directly folded outward and separated along the fold lines 3015,3016 to expose the sample application area of the testing element, thus being in contact with the fluid sample.

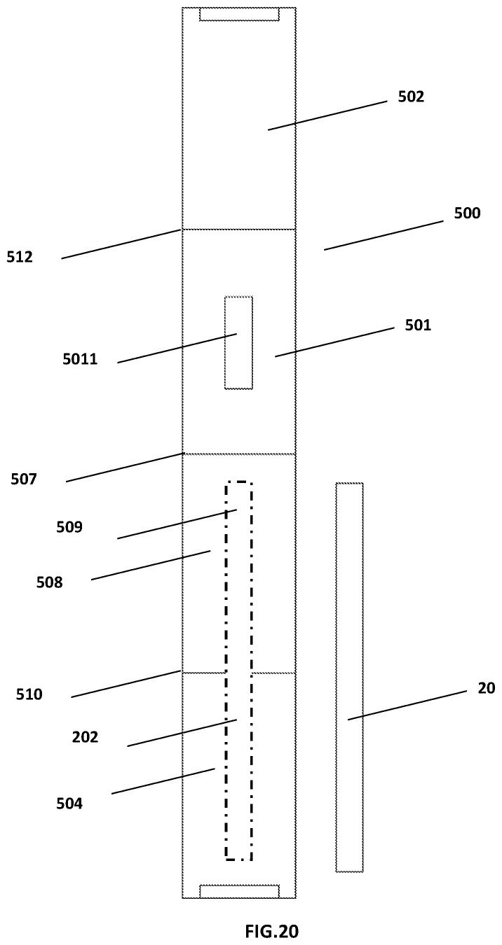

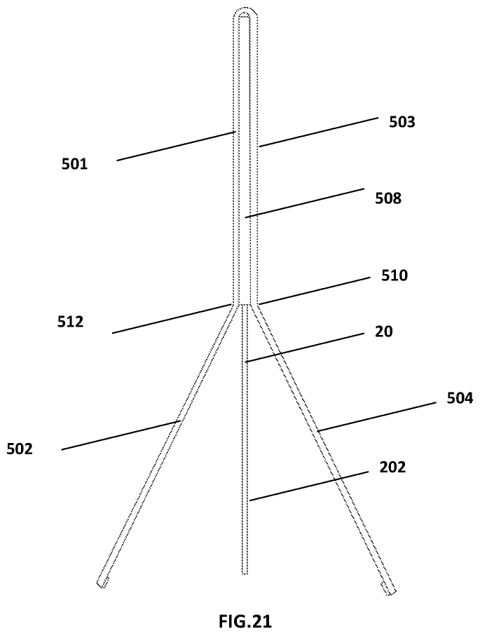

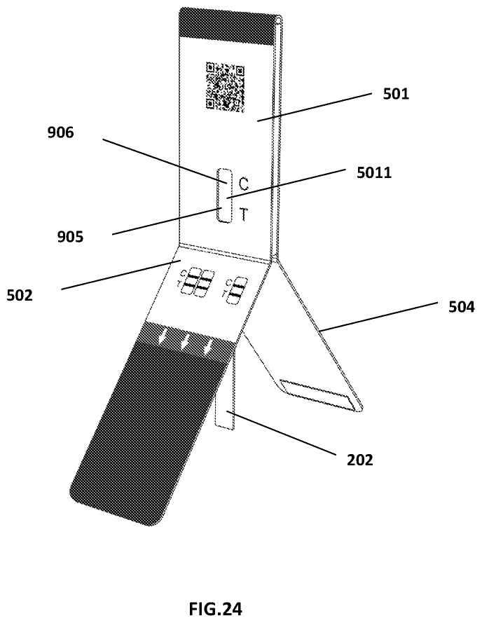

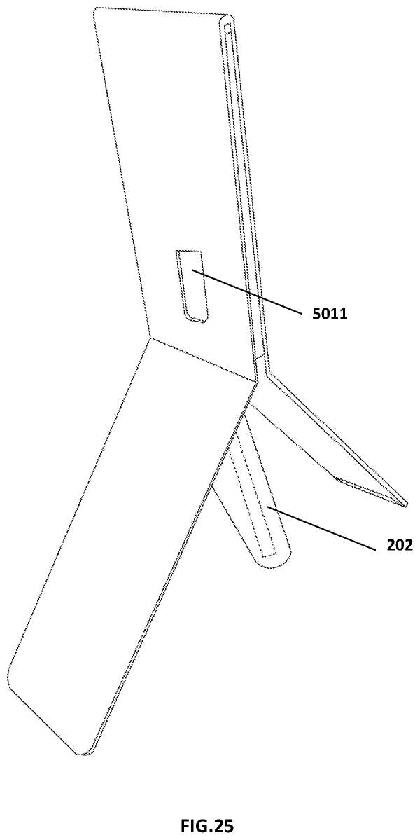

In some other embodiments, for example, as shown in FIGS. 20-25, a test card 500 is provided; the card consists of a foldable upper card 501 and a foldable lower card 503; the upper card is connected to the lower card via the fold line 507. The upper card 501 has a window 5011 for reading a test result on the test area 201 of the test element 20, and the lower card is directly pasted with a supporting pad 508 for bearing the test strip. The supporting pad may be a drying agent or drying paper or other shapes with double-sided glues; one side is directly bound to the lower card 503 and has a certain thickness, and the thickness is equivalent to the thickness of the testing element. In this way, when the upper 501 and lower cards 503 are closed and subsequently expanded, the testing element may be not extruded or pressed, but kept in a free state. Another side of the supporting pad 508 is bound to the upper card 501 such that the upper and lower cards are bound together via the supporting pad, and the testing element is also pasted on the supporting pad, particularly, the test area 201 of the testing element is pasted on the supporting pad as a fixed status. In some embodiments, movable cards 504 and 502 are separately connected to the upper card 501 and the lower card 503; the movable cards may be in closed and open states such that test card may test samples in a standing state (for example, as shown in FIG. 25). As can be seen from the example, the upper card 501, the lower card 503 and the supporting pad 508 as well as the test area portion of the testing element are bound together to form an integral part. In some embodiments, to protect the test area of the reading window, a layer of transparent film is pasted onto the upper card 501 to be bound to the test area 201 of the testing element, thus preventing the assembled structure from being affected with damp. Through such a design, the supporting pad plays a role of drying just as a drying agent thus, keeps the test area of the testing element in the drying environment, not susceptible to moisture. The movable elements, i.e., the movable cards 504 and 502 may be closed or expanded, but are not bound together, namely, may be separated according to different test requirements. The portion corresponds to the sample application portion of the testing element, and also a container where the testing element may be inserted (for example, a portion where the test tube contacts with samples). In this way, the movable elements 502,504 are expanded or closed to complete the whole test. In some other embodiments, for example, as shown in FIG. 19, a card 608 is disposed between an upper card 601 and a lower card 603; the card 608 has a thickness equivalent to the thickness of the testing element; the card has a notch 6081; the width of the notch is greater than that of the test strip, which is aimed at preventing flooding. After samples are absorbed by the testing element, if the gap between the notch and the testing element is very small, liquid flows along the gap quickly to moisten the downstream area of the testing element in advance. It will affect the test result. In some embodiments, to achieve the closure or expansion of the movable areas, the movable areas 602 and 604 have magnetic stripes 6041, 6021 for mutual attraction, or have areas with magic tapes, thus achieving automatic closure or expansion.

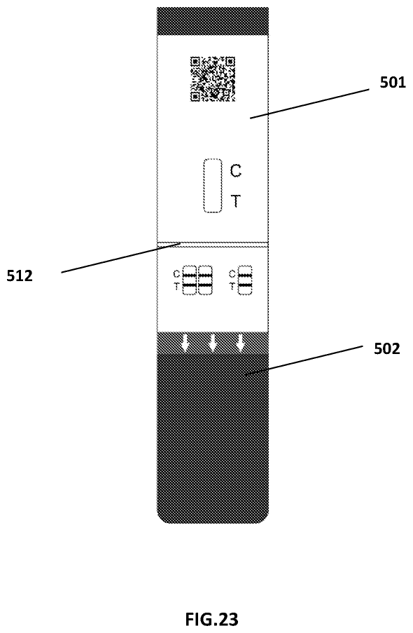

FIGS. 23-25 show detailed operating steps in one embodiment. FIG. 23 shows an assembled test card which has some letter or drawing as to guild user how to use the test card. Beside the window 5011, there is T and C letter as to there is a Test line or Control line to show the test result appearing on the test area 201 of the test element 20. When in need of detection, the movable elements 502, 504 are expanded or separated after overcoming mutual attraction of the magnetic strips to expose the sample application area 202 of the testing element, such that the movable elements 502 and 504 are unfolded to form an included angle. The sample application area 202 is then inserted into the test tube 40; if there is a liquid sample in the test tube, the test card is allowed to be kept standing on the test bench for detection. At the end of the detection, the test card may be taken out of the test tube; the movable elements 504 and 502 are closed again, a test result in the test area is read out through the reading window 5011, and then the test card is discarded. These are assembled via paper card without any plastic, which saves costs and relieves the pressure of environmental protection. For example, preferably, paper is a degradable material. Moreover, the paper material is light and convenient, thus reducing the pressure of transportation.

Test Device

The test device refers to a device for detecting the presence or absence of an analyte in a sample, including a testing element; the testing element is an element used for testing an analyte in a liquid sample. In some embodiments, the test device of the present invention may also include a container accommodating a fluid sample, and the container allows the sample application area of the testing element in the test device to be directly inserted, thus being in contact with the fluid sample. In some embodiments, the container accommodating a fluid sample may be a test tube; the test tube may be kept in a test tube stand (as shown in FIGS. 6-7), and of course, the test tube may be also kept in a hole of a packaging box (as shown in FIG. 8). The packaging box is a box body for packaging the test device and test tube.

All patents and publications mentioned in the description of the present invention are disclosures of the prior art and they may be used in the present invention. All patents and publications referred to herein are incorporated in the references as if each individual publication is specifically referred to separately. The present invention described herein may be practiced in the absence of any one or more of the elements, any one limitation or more limitations that are not specifically recited herein. For example, the terms “comprising”, “consisting of . . . substantively” and “consisting of . . . ” in each example herein may be replaced by the rest 2 terms. The so-called “a/an” herein merely means “one”, but does not exclude including 2 or more instead of including only one. The terms and expressions which have been employed herein are descriptive rather than restrictive, and there is no intention to suggest that these terms and expressions in this description exclude any equivalents, but it is to be understood that any appropriate changes or modifications can be made within the scope of the present invention and appended claims. It should be understood that, the embodiments described in the present invention are some preferred embodiments and features, and any person skilled in the art may make some changes and variations based on the essence of the description of the present invention, and these changes and variations are also considered to fall into the scope of the present invention and the independent claims and the appended claims.

1. A device for detecting an analyte in a fluid sample, wherein the device comprises a testing element, configured to be used to test the analyte in the fluid sample, and a housing accommodating the testing element therein; the housing is made of a paper material, wherein the housing is formed by folding.

2. The device according to claim 1, wherein the testing element comprises a test area and a sample application area for contacting the fluid sample, and the test area is in fluidic communication with the sample application area.

3. The device according to claim 2, wherein the housing comprises a window for reading a test results appearing on the test area of the testing element.

4. The device according to claim 3, wherein the folding is that an integral sheet is folded to form the housing; the housing has an area for accommodating the test area of the testing element and the sample application area of the testing element.

5. The device according to claim 4, wherein the housing comprises an expandable area and an unexpandable area containing the test area of the testing element therein; the expandable area comprises the sample application area of the testing element therein.

6. The device according to claim 5, wherein when the expandable area is opened, the sample application area of the testing element is exposed such that the sample application area is capable of being inserted into a container to contact the fluid sample therein.

7. The device according to claim 6, wherein when the expandable area is opened, the expanded area is capable of making the whole test device standing vertically.

8. The device according to claim 7, wherein the expandable area comprises two expanding elements; the sample application area of the testing element is located between the two expanding elements; when the expandable area is expanded, the two expanding elements are located at both sides of the sample application area separately, thus making the whole test device standing vertically.

9. The device according to claim 8, wherein the container containing the fluid sample is located on a supporting frame, and the two expanding elements are supported on the supporting frame, separately such that the whole test device is kept standing vertically.

10. The device according to claim 9, wherein the supporting frame is a test tube stand, or a socket of a packaging box.

11. The device according to claim 8, wherein the two expanding elements are capable of returning to an initial assembled state after the detection is finished; when in the initial state, the two expanding elements, are bound together via a bonding element.

12. The test device according to claim 11, wherein the bonding element comprises a magnetic material or a buckle structure disposed on the two expanding elements separately.

13. The device according to claim 8, wherein the unexpandable area comprises an upper and lower-layered paper card, and the test area of the testing element is located between the upper and lower paper card.

14. The device according to claim 13, wherein a paper card with a slot is disposed between the upper and lower paper card; the test area of the testing element is located in the slot, while the sample application area of the testing element is not located in the slot.

15. The device according to claim 13, wherein a supporting pad is disposed between the upper and lower paper card; the test area of the testing element is located on a frontside of the supporting pad; a back side of the upper paper card is partially bound to the frontside of the supporting pad, and the lower paper card is bound to a back side of the supporting pad, and the sample application area of the testing element is not located on the front side of the supporting pad.

16. The device according to claim 15, wherein a window is disposed on the upper paper card, and the window makes the test area exposed, thus being convenient for reading a test result on the test area.

17. The device according to claim 14, wherein the paper card with a slot, the upper and lower-layered paper card as well as the two expanding elements distributed on both sides of the test area of the testing element are formed by folding a paper.

18. The device according to claim 15, wherein the upper paper card and the lower paper card are formed by folding a paper; the upper paper card has a window for reading a test result and a first expandable element; the lower paper card has an area for supporting the supporting pad and a second expandable element.

19. The device according to claim 18, wherein the first expandable element and the second expandable element are capable of being in a closed state and an expanded state, wherein the first expandable element is connected to the upper paper card via a fold line and the second expandable element is connected to the lower paper card via the fold line.

20. The device according to claim 12, wherein the magnetic material comprises positive and negative electrodes disposed on the two expanding elements separately such that the two expanding elements are closed by attraction of the two electrodes; alternatively, the magnetic material comprises a magnet and a ferrous material disposed on the two expanding elements separately such that the two expanding elements are closed by mutual attraction.
